(19) United States
(12) Patent Application Publication
(10) Pub. No.: US 2004/0065178 A1
(43) Pub. Date: Apr. 8, 2004

(54) Multiple-in-1 precision hand tool

(76) Inventors: Wayne Anderson, Northport, NY (US); Paolo Cassutti, Northport, NY (US)

Correspondence Address: Marvin Feldman, Esq., LACKENBACH SIEGEL LLP, One Chase Road, Scarsdale, NY, 10583, US

(21) Appl. No.: 10/673,604

(22) Filed: Sep. 29, 2003

Related U.S. Application Data
(63) Continuation-in-part of application No. 10/000,926, filed on Oct. 19, 2001, now Pat. No. 6,655,243.
Application No. 10/000,926 is a continuation-in-part of application No. 09/435,709, filed on Nov. 8, 1999, now Pat. No. 6,374,711.
Application No. 09/435,709 is a continuation-in-part of application No. 09/168,637, filed on Oct. 8, 1998, now Pat. No. 6,209,428.
Application No. 09/168,637 is a continuation-in-part of application No. 08/960,090, filed on Oct. 24, 1997, now Pat. No. 5,819,612.
Application No. 09/168,637 is a continuation-in-part of application No. 08/977,453, filed on Nov. 24, 1997, now Pat. No. 5,904,080.
(63) Continuation-in-part of application No. 09/504,190, filed on Feb. 15, 2000, now Pat. No. 6,499,168.
Application No. 09/504,190 is a continuation-in-part of application No. 08/690,740, filed on Jul. 31, 1996, now Pat. No. 6,105,474.

(51) Int. Cl. B25B 23/16

(52) U.S. Cl. 81/177.4

(57) ABSTRACT

A multiple-in-1 hand tool stores multiple tool bits adjacent a handle proximate end and is removably joinable to a tool handle. A hand tool handle cap is removably attached to the hand tool enabling rapid tool bit access while enabling simple one-handed use.

PRIOR RELATED APPLICATIONS and PRIORITY CLAIM

This application claims priority from and is a continuation-in-part from U.S. Ser. No. 10/000,926 filed Oct. 19, 2001, now U.S. Pat. No.______, which was a continuation-in-part of U.S. Ser. No. 09/435,709 filed Nov. 8, 1999, now U.S. Pat. No. 6,374,711, which is a continuation-in-part of U.S. Serial 09/168,637, filed Oct. 8, 1998, which is a continuation-in-part of U.S. Ser. No. 08/960,090, filed Oct. 24, 1997, now U.S. Pat. No. 5,819,612, and a continuation-in-part of U.S. Ser. No. 08/977,453, filed Nov. 24, 1997, now U.S. Pat. No. 5,904,080, and a continuation-in-part of U.S. Ser. No. 09/504,190, filed Feb. 15, 2000, which is a continuation-in-part of U.S. Ser. No. 08/690,740, filed Jul. 31, 1996, now U.S. Pat. No. 6,105,474.

### BACKGROUND OF THE INVENTION

1. Field of the Invention

This invention relates to multiple-in-1 hand tools. This invention more specifically relates to multiple-in-1 precision and non-precision hand drive tools. This invention also specifically relates to combination multiple-in-1 precision hand tools.

2. Description of the Related Art

Precision hand tools or drivers are known in the art wherein the user engages the body of the tool handle with the thumb and middle finger and the index finger pressingly engages the proximate end of the handle. Fine rotational movement is achieved by the thumb and middle finger imparting a finely controlled torque movement to the handle body and in turn to the distally disposed tool bit.

It was known in the prior art to provide precision hand tool sets wherein the tool and interchangeable single-ended precision tool bits were stored in a case. Such prior art sets are shown in FIGS. 1A and 1B. FIGS. 1A and 1B depict a conventional precision tool set 10 wherein a case 15 contained the precision hand tool 11 and a number of interchangeable single-ended precision tool bits 12. The single-ended tool bits 12 were individually stored in case 15, and selectively slidably operably disposed at the distal end 16 of hand tool 11. These sets were undesirable in that the user had to carry and access the case 15 at and to the work site. The small single-ended precision tool bits when removed from the case would be readily lost or misplaced.

FIG. 2 depicts another conventional precision hand tool set 13, wherein a series of precision screwdrivers 17-24 were stored in the case 29 with different tool bit configurations formed at the respective ends of the fixedly disposed shanks. Tool set 13 was bulky and cumbersome in use, and only a limited number of drive functions were practically available. Additionally, the user had to access the bulky case and tool set at the work site.

It was also known in the prior art to provide a precision hand tool wherein interchangeable precision single-ended tool bits were loosely stored in the handle. Such hand tools are shown in FIGS. 3A and 3B. Specifically, FIGS. 3A and 3B depict a precision hand tool 25 wherein a number of elongated single ended tool bits 26 (typical) were loosely stored in the hollow handle 27. The user would remove end cap 28 and shake out the tool bits and then insert the desired selected tool bit in the distal end 29 of tool 25. The FIGS. 3A and 3B hand tool was undesirable in that the small precision tool bits would be damaged in loose common storage, and it was difficult to selectively retrieve just the desired tool bit without misplacing the other tool bits. The prior art tool of FIGS. 3A and 3B also suffered the impediment of requiring a large number of single-ended bits to accomplish an equally large number of drive functions. The precision size handle could not however accommodate a sufficient number of such bits.

FIGS. 4A and 4B depict still another prior art precision tool set 30. Tool set 30 contains a precision hand tool 31 with a flexible shaft 32, a sleeve 32a and, generally six single-ended tool bits 33 (typical). The single-ended tool bits 33 were mounted in a case 34. Sleeve 32a was slidably received over flexible shaft 32 to, alternately, use the tool as a non-flexible shaft tool. Each tool bit 33 was slidably non-rotatably operably disposed in the distal end 36 of hand tool 31. Set 30 required a case 34 for storage and the removed loose tool bits 33 would be readily lost or misplaced.

The prior art was generally directed to highly elongated single-ended precision tool bits. These tool bits were formed from wire blanks of exceptional length. FIG. 16 shows a typical prior art single-ended precision tool bit. It was believed that the exceptional length was required to achieve an accurately machined precision tool bit ends. These exceptional length precision tool bits militated against stowage in precision sized hand tool handles.

The prior art, as demonstrated in FIGS. 1-4B and 16, 17 was directed to providing single-ended precision tool bits. The prior art, as shown in FIGS. 2-4B and 16, 17 was instead directed to precision single-ended tool bits with exceptionally elongated body portions.

The art desired a practical multiple function, multiple-in-1 drive tool.

The present invention additionally pertains to multi-purpose hand tools including a multiple-in-1 functional tool having a multiple bit drive functions.

### OBJECTS AND SUMMARY OF THE INVENTION

An object of the present invention is to provide a multiple-in-one precision or non-precision hand tool, particularly a precision or non-precision screw/nut driver.

In one aspect, the present invention is a multiple-in-1 precision hand tool. In another aspect, the present invention is a precision hand tool with a multiple-in-1 drive function.

In still another aspect, the present invention is a hand tool with double-ended or double-headed tool bits. The double-ended tool bits are practically stored within elongated compartments of the hand tool handle.

One of the present embodiments includes double-ended tool bits specifically proportioned with each bit end and central body being of the same length, and within a practical overall minimal length. The limited overall length made it possible to store a plurality of such double-ended bits in the handle of a precision sized hand tool. The tool bits are alternatively operably received in the precision handle cap and at the distal end of the precision hand tool shank for alternate drive use.

In still further aspects, the present invention is a precision hand tool with ergonomic handle construction.

In still further aspects, the present invention contemplates a hand tool and hand tool handle which combines one or more of the afore-described inventive features of the present invention.

The present invention provides a self-contained, improved hand tool having no loose parts, such as folding pocket-type knives with the flexibility and functionality of multipurpose tools. The present invention provides, among other hand tools, a folding combination pocket-type knife with the professional usefulness of interchangeable bit screwdrivers and offset screwdrivers using the same interchangeable bit. In particular, the present invention provides hinged sleeve means which removably retains screwdriver bits in hinged relationship to a handle adapted to receive the sleeve and bit in recessed storage relationship and in exposed functioning relationship. The sleeve means has retaining means which cooperates with the bit to removably secure the bit in the sleeve. The double ended bit is interchangeable with other bits and is reversible, having a different drive at each end.

The present invention in another embodiment has a hexagonal or other shaped cross-hole, extending from one side to the other of the handle, to receive the interchangeable bits (having a matching cross-section) in perpendicular relation to the handle, creating an offset interchangeable bit section of the invention. Retractable and/or biasable ball retaining means, or magnets, or retaining clips on each interchangeable bit may be used to retain the offset bit by fitting between the side bolsters and being retained thereby. Also, with the various hand tools of the invention, the folding blades may suitably have conventional provisions for locking in the open positions any of the tools for safety so as to prevent tools and blades from unexpectedly snapping closed.

The present invention, in some aspects, contemplates a precision or a non-precision hand tool, having multiple attachments for nuts/bolts, stored in the body of another multiple-in-one hand tool.

The present invention additionally relates to multiple-in-one hand tools removably enclosing and pivotably storing precision and non-precision hand tools enclosing and storing multiple precision and non precision tool bits/nut drivers. More specifically the present invention additionally describes multiple-in-1 precision hand tools removably stored in separable multiple-in-1 folding hand tools to maximize a user's convenience.

The present invention additionally relates to a multi-function hand tool having pivoted elongated first and second asymmetrical handles with opposed pliers jaws or related ends at respective first ends of the handles, a closed ended sleeve being pivotally and non-removably connected to the second end of the first handle for pivoting from an inoperable position to an operable position, with the sleeve operably receiving interchangeable tool bits or a precision hand tool capable of separate and individual use and self storage of too bits, to provide a multiple tool bit driver tool, and at least one bladed tool pivotally connected to the second end of the first handle for pivoting from an inoperable position to an operable position, and the first handle second end having a box construction to store the tools in their inoperable positions.

According to one further embodiment of the present invention, there is provided a hand tool has a pliers with pivotably disposed handles with one handle having a closed ended sleeve pivotably connected to one handle head for removably operably receiving tool with the sleeve non-removably bits pivoting from a first position between the handle sides to a second position, and the other handle has at least one bladed tools pivotally connected to the handle end.

According to an embodiment of the present application there is provided a multiple-in-1 hand tool comprising: at least one interchangeable tool bit member, opposed pliers jaws, first and second elongated handles having oppositely disposed first and second ends, the pliers jaws being operably disposed at the first ends, the first handle having opposed sides forming an elongated cavity, a bladed tool, and means for pivotably connecting the bladed tool to the first handle adjacent the first handle second end, a sleeve comprising a one-piece unitary construction formed with a tubular body, the tubular body being formed with a wing member extending away from the outside of the tubular body, having a closed-end and an open end, the open end being formed for storing the tool bit member, the tool bit member being disposed in the sleeve, means for pivotably fixedly connecting the sleeve adjacent the first handle second end so that the sleeve is non-removable, whereby the sleeve and the tool bit member are pivoted from a first position disposed away from the first handle to a second position disposed in the first handle cavity so that the sleeve and the tool bit member are inoperably stowed in the first handle without having to remove and separately stow the tool bit member or sleeve outside the first handle cavity thereby permitting ready alternate pliers or multiple-in-one tool bit use.

According to another embodiment of the present invention, there is provided a multiple-in-1 hand tool wherein, the tubular body having an outer surface, the sleeve closed-end having a flat end wall portion, the flat end wall portion extending to the tubular body outer surface.

According to another embodiment of the present invention, there is provided a multiple-in-1 hand tool, wherein: the tool bit member comprising a double-ended tool bit, the double-ended tool being removably disposed between the first handle sides with the sleeve disposed in the inoperable position.

According to another embodiment of the present invention, there is provided a multiple-in-1 hand tool comprising: at least one interchangeable tool bit member, opposed pliers jaws, first and second elongated handles having oppositely disposed first and second ends, the pliers jaws being operably disposed at the first ends, the first handle having opposed sides forming an elongated cavity, a bladed tool, and means for pivotably connecting the bladed tool to the first handle adjacent the first handle second end, a sleeve comprising a one-piece unitary construction formed with a tubular body, the tubular body being formed with a wing member extending away from the outside of the tubular body, and the tubular body having a closed-end and an open end, the open end being formed for removably storing the tool bit member, the tool bit member being disposed in the sleeve, means for pivotably fixedly connecting the sleeve adjacent the first handle second end so that the sleeve is non-removable, whereby the sleeve and the tool bit member are pivoted from a first position disposed away from the first handle to a second position disposed in the first handle cavity so that the sleeve and tool bit member are inoperably stowed in the first handle without having to remove and separately stow the tool bit member or sleeve outside the first handle cavity thereby permitting ready alternate or tool bit use.

According to another embodiment of the present invention, there is provided a multiple-in-1 hand tool wherein: the tubular body having an outer surface, the sleeve closed-end having a flat end wall portion, the flat end wall portion extending to the tubular body outer surface. According to another embodiment of the present invention, there is provided a multiple-in-1 hand tool, wherein: the tool bit member comprising a double-ended tool bit, the double-ended tool being disposed between the first handle sides with the sleeve disposed in the inoperable position.

According to another embodiment of the present invention, there is provided a multiple-in-1 hand tool wherein: the wing member extends axially along the outside of the tubular body.

According to another embodiment of the present invention, there is provided a multiple-in-1 hand tool comprising: at least one interchangeable tool bit member, opposed pliers jaws, first and second elongated handles having oppositely disposed first and second ends, the pliers jaws being operably disposed at the first ends, the first handle having opposed sides forming an elongated cavity, a bladed tool, and means for pivotably connecting the bladed tool to the first handle adjacent the first handle second end, a sleeve comprising a one-piece unitary construction formed with a tubular body, the tubular body being formed with a wing member extending away from the outside of the tubular body, and the tubular body having a closed-end and an open end, the open end being formed for removably storing the tool bit member, the tool bit member being disposed in the sleeve, means for pivotably fixedly connecting the sleeve adjacent the first handle second end so that the sleeve is non-removable, whereby the sleeve and the tool bit member are pivoted from a first position disposed away from the first handle to a second position disposed in the first handle cavity so that the sleeve and tool bit member are inoperably stowed in the first handle without having to remove and separately stow the tool bit member or sleeve outside the first handle cavity thereby permitting ready alternate pliers or tool bit use, the tubular body having an outer surface, the sleeve closed-end having a flat end wall portion, the flat end wall portion extending to the tubular body outer surface, and the tool bit member comprising a double-ended tool bit, the double-ended tool being disposed between the first handle sides with the sleeve disposed in the inoperable position.

According to another embodiment of the present invention, there is provided a multiple-in-1 hand tool wherein: the wing member extends axially along the outside of the tubular body.

According to another embodiment of the present invention, there is provided a multiple-in-1 hand tool comprising: a tool bit member and a tool handle, the tool handle having a sleeve comprising a one-piece unitary construction formed with a tubular body, the tubular body being formed with awing member extending axially along the outside of the tubular body, and the tubular body having a closed-end and an open end, the open end being formed for removably storing the tool bit member, the tool bit member being disposed in the sleeve in a storage mode and removable for use during a use mode, means for pivotably fixing the closed end of the tubular body to the tool handle whereby the sleeve and the tool bit member are pivoted from a first position disposed away from the first handle to a second position disposed in a first tool handle cavity so that the sleeve and tool bit member are inoperably storable in a first handle cavity without having to remove and separately store the tool bit member or sleeve outside the first handle, thereby permitting ready alternative tool bit member use apart from the tool handle.

According to another embodiment of the present invention, there is provided a precision multiple-in-1 hand tool wherein: the tool bit member further comprises a body and an oppositely opened tool bit storage and holding cavity for receiving at least a tool bit during the use mode of the hand tool, a plurality of storage cavities in the body opposite the storage and holding cavity for removably storing a plurality of tool bits, and a top member on the tool bit member removably covering the plurality of storage cavities while providing a ready access.

According to another embodiment of the present invention, there is provided a multiple-in-1 hand tool comprising: an intermediate sleeve slidably storable in the oppositely opened tool bit storage and holding cavity for receiving a precision tool bit during the use and enabling a retainment of the tool bit during staid storage mode.

According to another embodiment of the present invention, there is provided a multiple-in-1 hand tool, wherein: at least two tool bit members are disposed in the sleeve, whereby the two tool bit members enable a plurality of removable and useable tool bit members with a plurality of storage and holding cavities.

According to another embodiment of the present invention, there is provided a multiple-in-1 hand tool comprising: a precision hand tool including multiple and interchangeable tool bits in at least a storage body, at least one tool handle having the first handle having opposed sides forming an elongated cavity and a one piece unitary sleeve member pivotably joined relative to a first end of the tool handle and having a closed-end and an open end, the open end being formed for removably storing the precision hand tool, and the hand tool being removably disposed in the sleeve, whereby the sleeve and the hand tool are pivoted from a first position disposed away from the first handle to a second position disposed in the first handle cavity so that the sleeve and hand tool are inoperably stowed in the first handle without having to remove and separately stow the tool bit member, handle, or sleeve outside the first handle cavity thereby permitting ready alternate use of the tool bit.

The above, and other objects, features and advantages of the present invention will become apparent from the following description read in conduction with the accompanying drawings, in which like reference numerals designate the same elements.

### BRIEF DESCRIPTION OF THE DRAWINGS

FIG. 1A is a front elevational view of a conventional precision hand tool set in its carrying case.

FIG. 1B is a side elevational view of the precision hand tool of the set of FIG. 1A.

FIG. 2 is a front elevational view of a second conventional precision hand tool set in its case and with one precision hand tool removed.

FIG. 3A is a side elevational view of a third conventional precision hand tool.

FIG. 3B is an exploded side view of the precision hand tool of FIG. 3A.

FIG. 4A is a front elevational view of a fourth conventional precision hand tool set in its case mounted on a display card.

FIG. 4B is a series of side elevational views of the precision hand tool removed from the set of FIG. 4A in various non-flexed and flexed shaft modes.

FIG. 5 is a exploded top perspective view of the precision hand tool of the present invention.

FIG. 6 is a top perspective view of the assembled precision hand tool of FIG. 5 with the tool bit operably disposed and shank retracted.

FIG. 7 is of a sectional view of handle of FIG. 6 without the shank.

FIG. 8 is a sectional view of the precision hand tool taken along line 8-8 of FIG. 6.

FIG. 9 is an enlarged sectional view taken along line 9-9 of FIG. 8.

FIG. 10 is a sectional view of the handle of the handle and a side elevational assembly view of a shank.

FIG. 11 is an enlarged view of the proximate end of the handle of FIG. 10.

FIG. 12 is a sectional view of the assembled tool of FIG. 5 with the shank fully extended.

FIG. 13 is a greatly enlarged sectional view taken along line 13-13 of FIG. 12.

FIG. 14 is a perspective view of the precision tool of FIG. 12 in one mode of use.

FIG. 15 is a perspective view of the precision tool of FIG. 12 in a second mode of use.

FIG. 16 is a respective side elevational and top plan view of a conventional single-ended precision tool bit.

FIG. 17 is a side elevational view of a conventional non-precision double-ended tool bit.

FIG. 18 is a side elevational view of the precision double-ended tool bit of the present invention.

FIG. 19 is a perspective view of the handle cap of FIG. 5 with a tool bit being demagnetized.

FIG. 20 is a perspective view of the handle cap of FIG. 19 with a tool bit being magnetized.

FIG. 21, is a perspective view of the handle cap of FIG. 19, showing insertion of the tool bit.

FIG. 22 is a perspective view of the handle cap of FIG. 19, with the tool bit inserted.

FIG. 23 is a side view of an alternative embodiment of a multiple-in-1 precision hand tool including a screwdriver.

FIG. 23A is a partial top view of an alternative embodiment of a multiple-in-1 precision and non precision hand tool showing the wing member transition of FIG. 23.

FIG. 24 is a side view of a multiple-in-1 precision hand tool in a retracted position.

FIG. 24A is a partially cut away side view of a multiple-in-1 precision hand tool showing a centrally disposed cross-bore on one handle for driving both the hexagonal driver sleeve and the driver bit.

FIG. 24B is a top view of the embodiment shown in FIG. 24A.

FIG. 25 is a top view of the multiple-in-1 precision hand tool of FIG. 24

FIG. 26 is a side view of an alternative embodiment of a multiple-in-1 hand tool in which a hand tool (in this case a multiple-bit driver element) is pivotally and removably mounted on one handle free end and stores a precision screw/nut driver tool stored in a sleeve member shown in a partially open position with the driver sleeve additionally shown individually for clarity.

FIG. 26A is a top view of FIG. 26.

FIG. 27 is an exploded side view of a precision hand tool-screw driver shown in FIG. 26.

FIG. 28 is a partial sectional view along line I-I in FIG. 27 noting the storage cavities for multiple precision screw/nut bits.

FIG. 29 is a side view of a Leatherman-type tool in accordance with the invention in which a multiple-bit driver element is pivotally and removably mounted on one free end of one of the handles and multiple additional tools are pivotally mounted at the free end of the other handle.

FIG. 30 is an exploded view of the precision multiple-in-one hand-tool driver element as shown in FIG. 29.

### DETAILED DESCRIPTION OF THE PREFERRED EMBODIMENTS

It is contemplated that the present invention involves a multiple-in-1 screw driver tool member enabling use with or for use in combination with multiple handle portions while enabling storage and use of multiple tool bits. It is further contemplated that the use of the present multiple-in-1 screw driver in such diverse combinations increases substantially a utility and a convenience of the entire multiple-in-1 screw driver and tool handle combination. Tool handles are unlimited herein but presently include at least a knife tool handle, a hammer tool handle, a vice grip tool handle, and a pry bar tool handle.

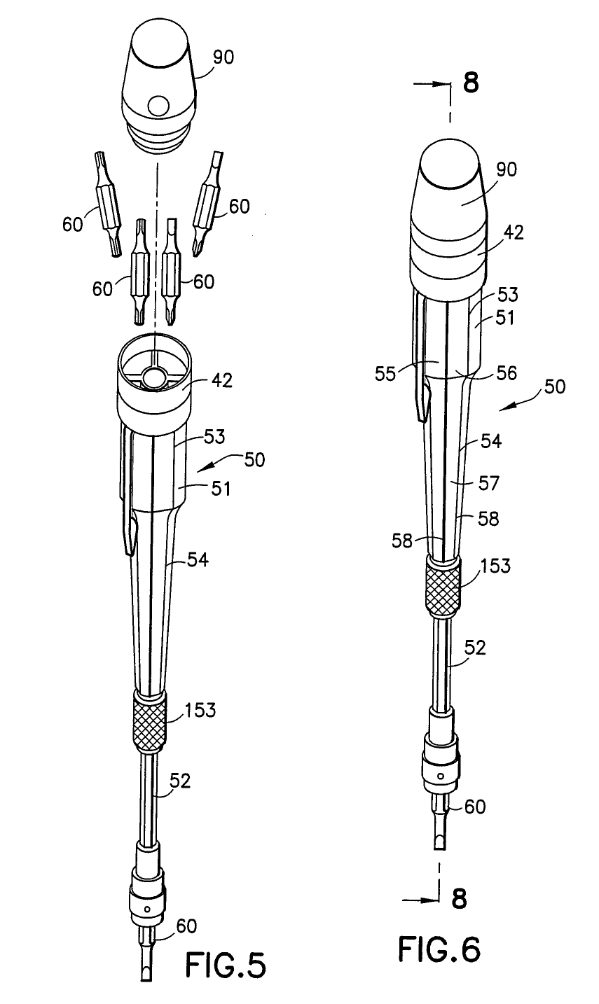

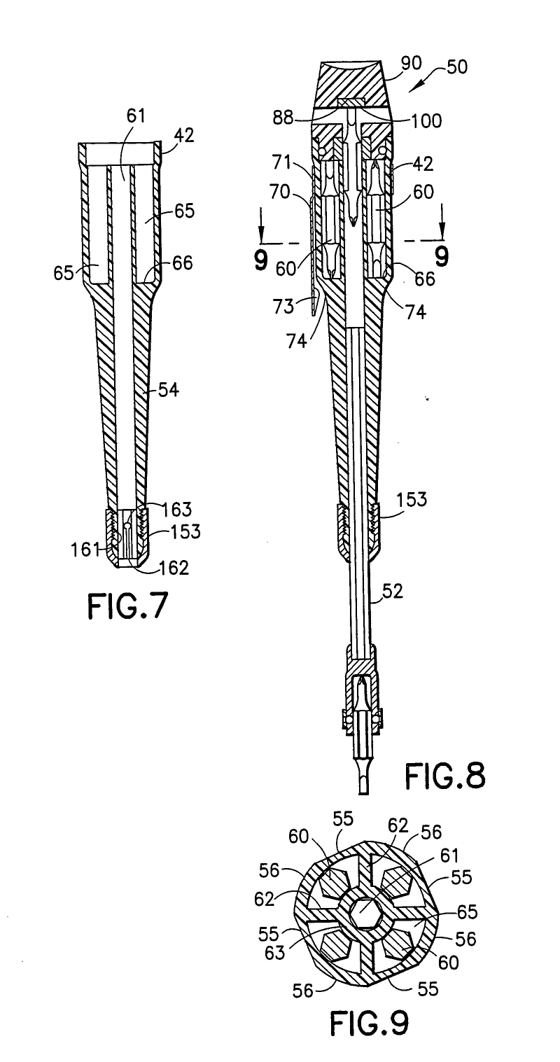

Referring to FIGS. 5-15 and 18-22 there is shown precision hand tool 50. Precision hand tool 50, in general terms, includes removable handle cap 90, transparent plastic handle or handle body 51, hexagonal cross-sectioned metal shank 52, shank lock nut 53, distally disposed sleeve assembly 57 and six double-ended precision tool bits 60 (typical). The six double-ended tool bits 60 provide a 12-in-1 drive functionality. Handle 51 is of clear thermoplastic construction. Handle 51 includes a proximately disposed circular cylindrical portion 42, a first body portion 53, and a second body portion 54. First body portion 53 has four equally sized flat walls 55 (typical) and four equally sized curved or arcuate walls 56(typical). Walls 55 and 56 have about the same surface area (See FIGS. 6 and 9). Second body portion 54 has eight distally tapered flat walls 57(typical) and eight corners 58(typical). Each second portion wall 57 is contiguous with one of the first portion walls 55 or 56 as at common recess 74. First and second body portions 53 and 54 are formed with a central axially disposed cylindrical hole 61, and distal end of body portion 54 is formed with central hexagonal hole 161 for purposes hereinafter appearing. First body portion 53 is formed with four radially disposed walls 62, and central cylindrical wall 63 which in turn forms four wedge shaped recesses or compartments 65 having distal end walls 66. Each compartment 65 slidably receives or stows a respective double-ended tool bit 60.

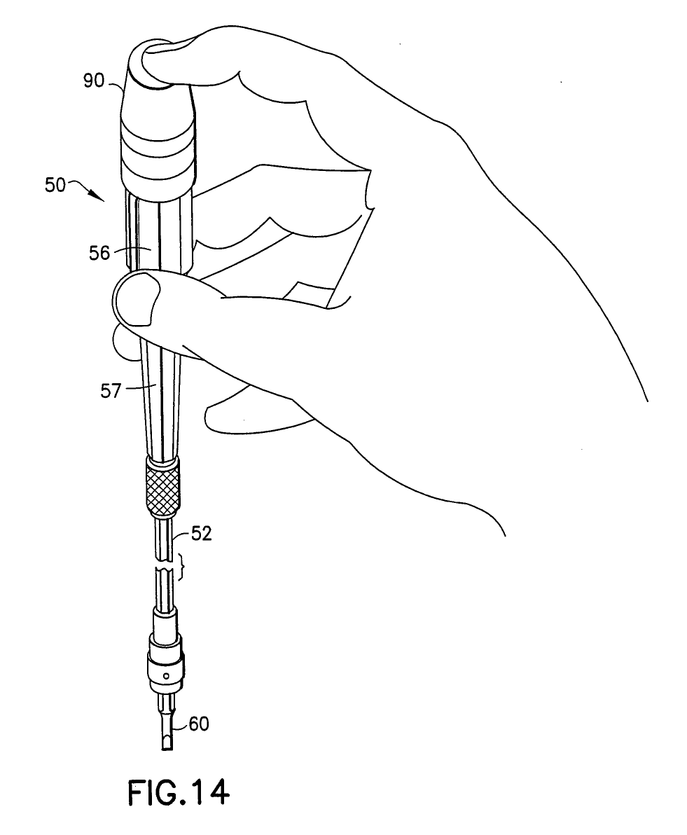

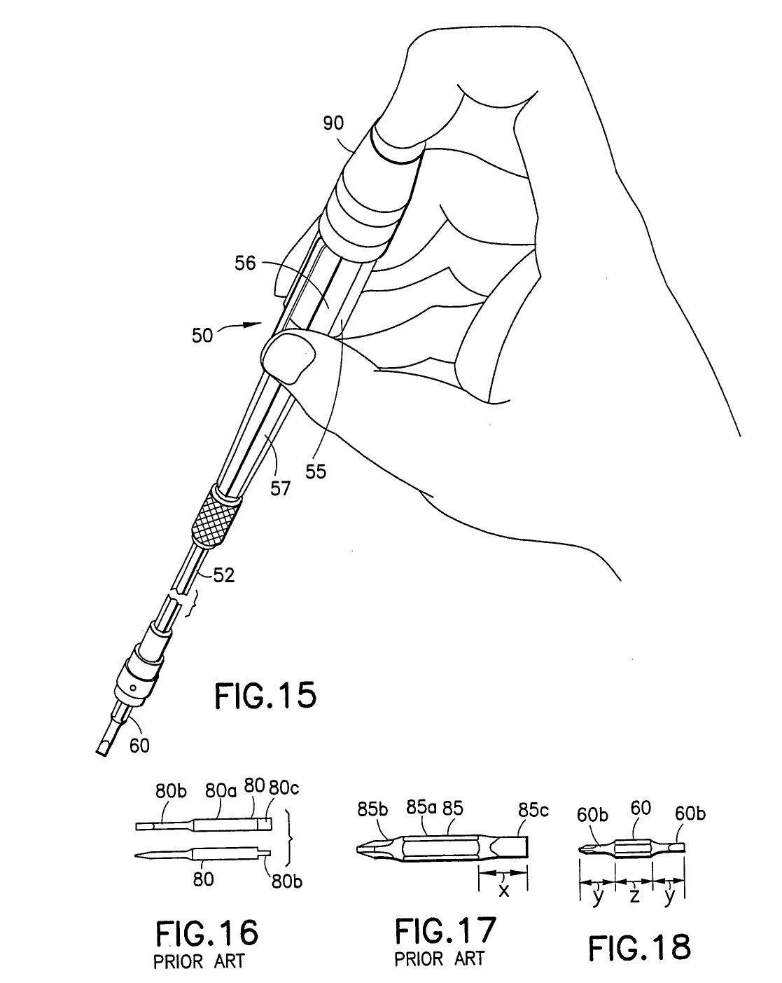

First body portion 53 and second body portion 54 provide an ergonomic handle construction, wherein the user can selectively in diverse combinations grip the flat walls 55, arcuate walls 56 tapered walls 57 for best desired comfort and control. By way of example, with the shank fully extended, the user may want particularly fine control. The walls 55, 56, and 57 provide diverse ergonomic grip arrangements for diverse fine precision drive operations. Two such grip examples are shown in FIGS. 14 and 15, respectively.

A metal pocket clip 70 has a cylindrical holder portion 71 which is slidably received on the outer cylindrical surface of handle proximate portion 42 Pocket clip 70 includes pocket engaging portion 72, which extends distally to wherein clip end 73 is disposed adjacent corner recess 74.

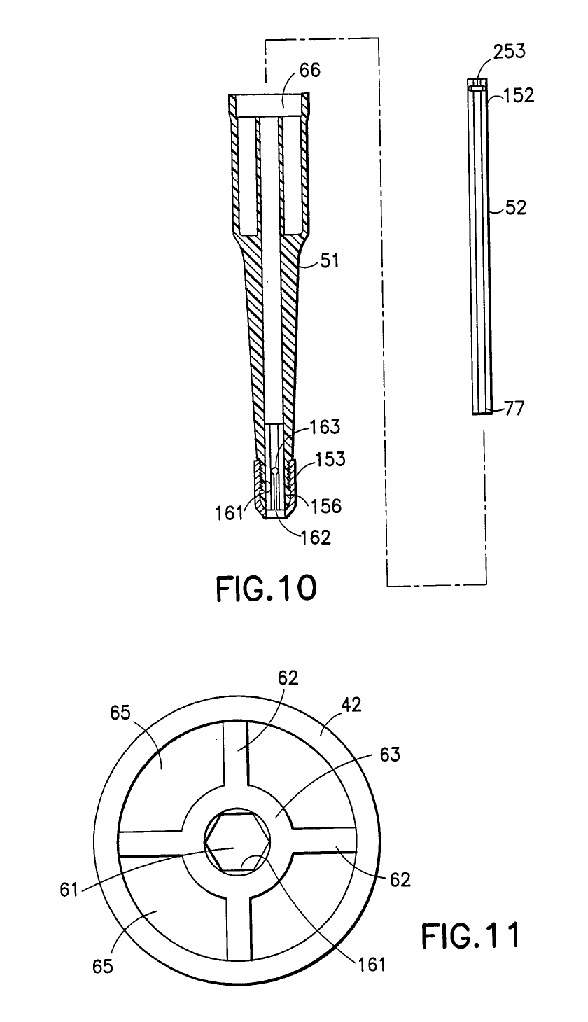

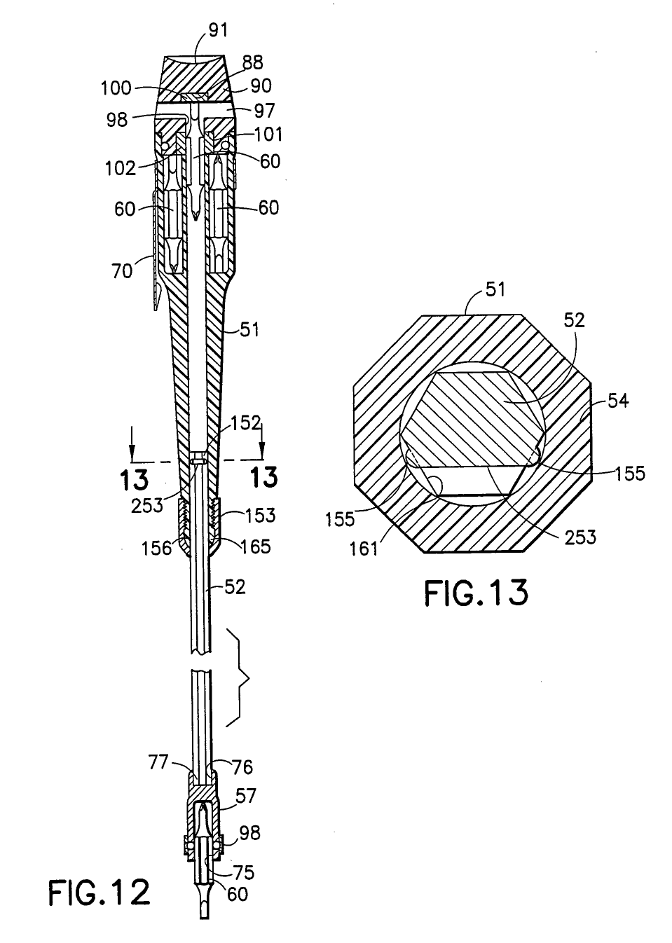

Shank 52 is slidably disposed in proximately disposed central axially disposed cylindrical hole 61 and distally disposed hexagonal hole 161, whereby shank 52 can be slidably extended for precision drive use in impeded access operations such as electronics equipment. Lock nut assembly 153 locks the extended shank 52 in the extended desired position. Referring specifically to FIGS. 10-13, there is shown certain details of tool 50 with regard to the lower or distal body portion 54 and the proximate end 152 of shank 52. Shank proximate end 152 is formed with a transverse groove 253 and oppositely disposed ears 155. Ears 155 frictionally engage the corners of hexagonal hole 161 and thereby functions as a stop to retain the shank 52 within the plastic handle body. Sleeve portion 161 is formed with a vertically disposed slot 162 having an enlarged rounded stress relief blind edge 163. In molding the handle, shank 52 is slidably received in the distal end hole 61 of handle 51, when the thermoplastic body is just molded and readily thermoplastically deformable. The shank 52 is then moved distally to cover the ears 155 to gouge the thermoplastically deformable walls of hexagonal recess of sleeve 161 and in doing so form a stop. In operation, shank 52 slides freely through central cylindrical hole 61, until the ears 155 engage the corners of hole 161. That is, shank end 152 engages the proximate end hexagonal sleeve portion 161 to stop further movement. When shank 52 is fully extended, as shown in FIGS. 12 and 13, shank ears 155 frictionally engage two corner walls of hexagonal sleeve portion 161 and exert radial forces on the plastic sleeve. Slot 162 and slot end 163 relieve the radial force stress to avoid fractures in the plastic handle. In this manner of construction, frictionally engaged shank 52 is prevented from sliding out the distal end 156 of handle 51. Lock nut 153 screw engages the distal end 165 of handle 51 so that with the fastening of lock nut 153, shank 52 is fixed in its extended position. The shank distal end 152 portion disposed hexagonal sleeve end portion 161 spatial arrangement and construction distribute the bending forces caused by extended shank flexure thereby presenting plastic handle fracture.

Sleeve assembly 57 includes a distal hexagonal recess 75 for slidably non-rotatably operably receiving a tool bit 60. Sleeve assembly 57 is also formed with a proximately disposed hexagonal recess 76 for fixedly non-rotatably receiving the distal end 77 of hexagonal shank 52. Sleeve assembly 57 is also formed with a lock collar and ball retainer assembly 78 for holding tool bit 60 in place in sleeve recess 75. With tool bit 60 removed, sleeve assembly hexagonal end recess 76 serves as a precision nut driver.

Handle cap 90 is formed with a proximately disposed slight depression or recessed surface 91 for receiving the end of the user's index finger. Cap 90 has a fustro-conical body 92. Handle cap 90 has a cylindrical distal end portion 93 formed with a circumferential groove 191 for receiving a snap-on O-ring. Cap distal portion 93 is slidably received in the proximate end recess 66 of handle 51, and removably held therein by the O-ring in handle body circumferential groove. Attached cap 90 swivels in handle body recess 66. Cap 90 covers the four tool bits 60 stowed in the elongated arcuate handle compartments 65.

Handle cap 90 is formed with a transversely disposed cross-hole 97, and an axially disposed cylindrical recess 98 which communicates with cross-hole 97. A cylindrical or pill shaped rare earth permanent magnet 100 is secured in recess 88 by known means, for purposes hereinafter appearing. Cap 90 is also formed with a distal end stepped recess 101 for non-rotatably receiving metal insert 102. Insert 102 is formed with a hexagonal inner bore 103 which is sized to slidably receive the body 60a of double-ended precision tool bit 60 typical. Handle cap and metal insert hexagonal bore 103 function as a mini nut drive tool with cap 90 detached from the handle body and with tool bit removed. With tool bit 60 disposed in bore 103, one tool bit end 60b contactingly engages magnet 100 and the other tool bit end 60b is operably disposed, as best shown in FIGS. 14-17. Magnet 100 magnetically holds tool bit 60 in cap 90. Distally disposed tool bit end 60b is magnetized to magnetically hold a fastener such as a screw (not shown). In this manner of construction, handle removed cap 90 with tool bit 60 magnetically held functions as a mini precision screwdriver. Of course, any one of the six tool bits can be selectively magnetically held and operably disposed in removed handle cap 90.

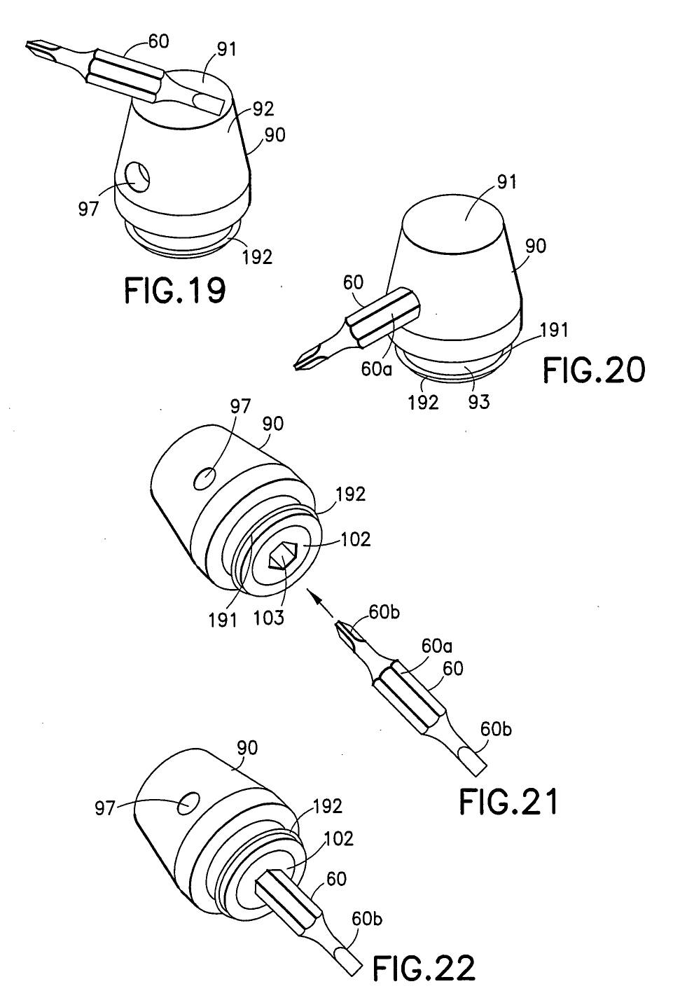

Cap cross-hole 97 is sized to slidably receive a selected tool bit 60 so that tool bit 60 is magnetized by magnet 100 (FIG. 20). The magnetized tool bit can then be mounted in distal recess 75 whereat the operably disposed magnetized tool bit end can hold a screw or like ferro-metallic drive element (not shown). A further feature of the present tool is that by striking a magnetized tool bit across cap proximate shallow recessed surface 91, the tool bit becomes demagnetized (FIG. 19).

Magnet 100 is a rare earth magnet as shown and described in U.S. Pat. No. 6,181,229, U.S. Pat. No. 5,794,497, U.S. Pat. No. 6,026,717 and U.S. Pat. No. 6,026,718, which patent disclosures are incorporated herein by reference thereto. Magnet 100 has an energy product of at least about 6.0×106 gauss-oersteds, and preferably at least about 7.0×106 gauss-oersteds.

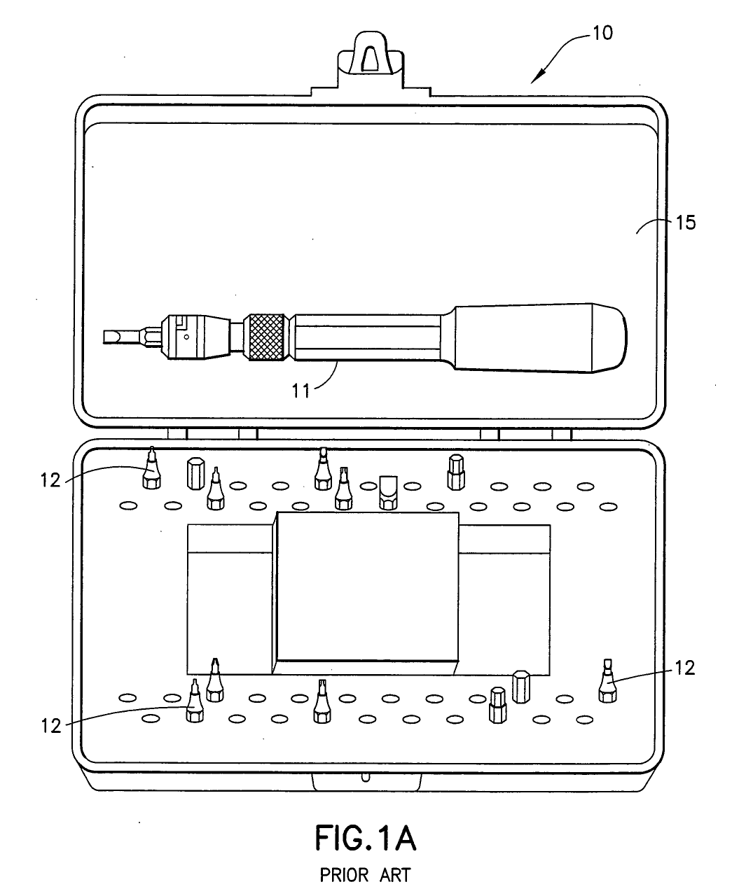

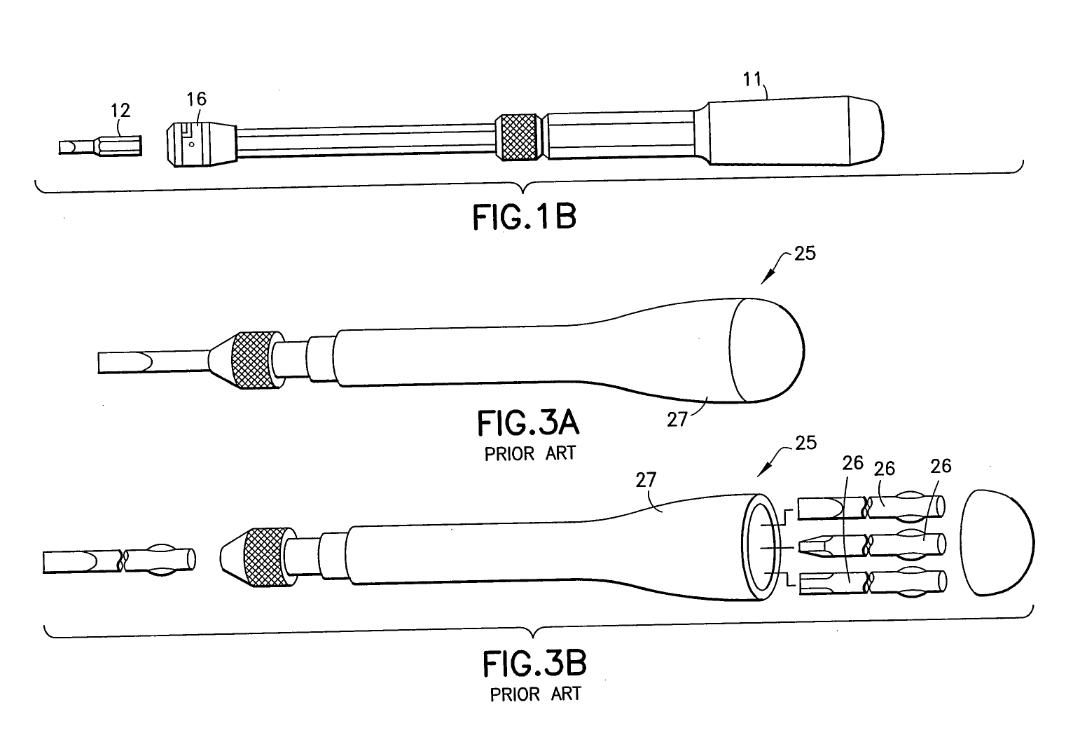

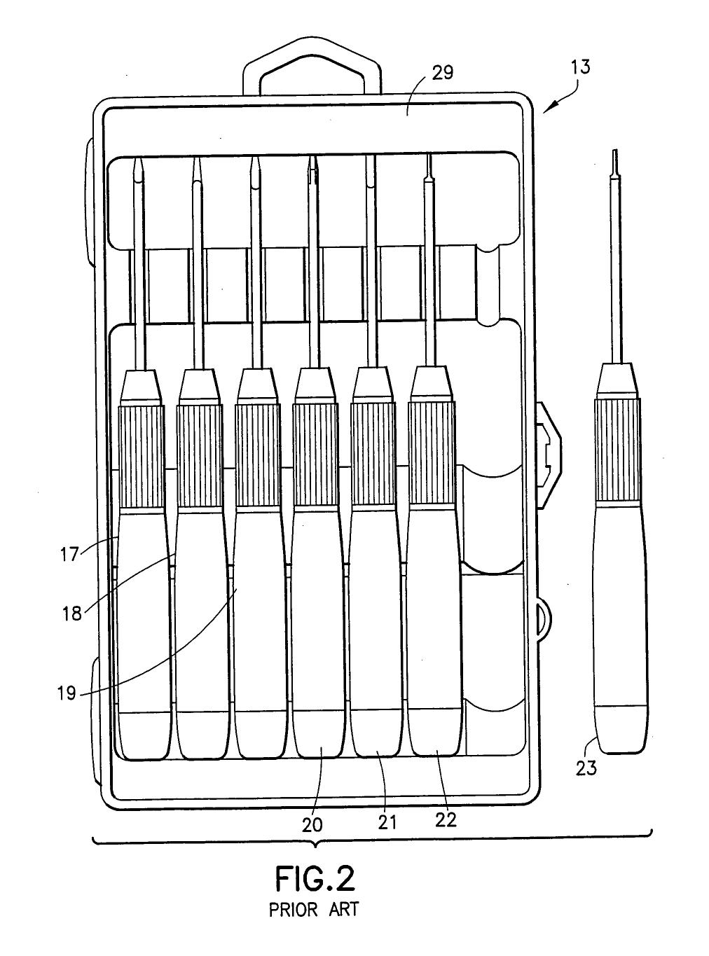

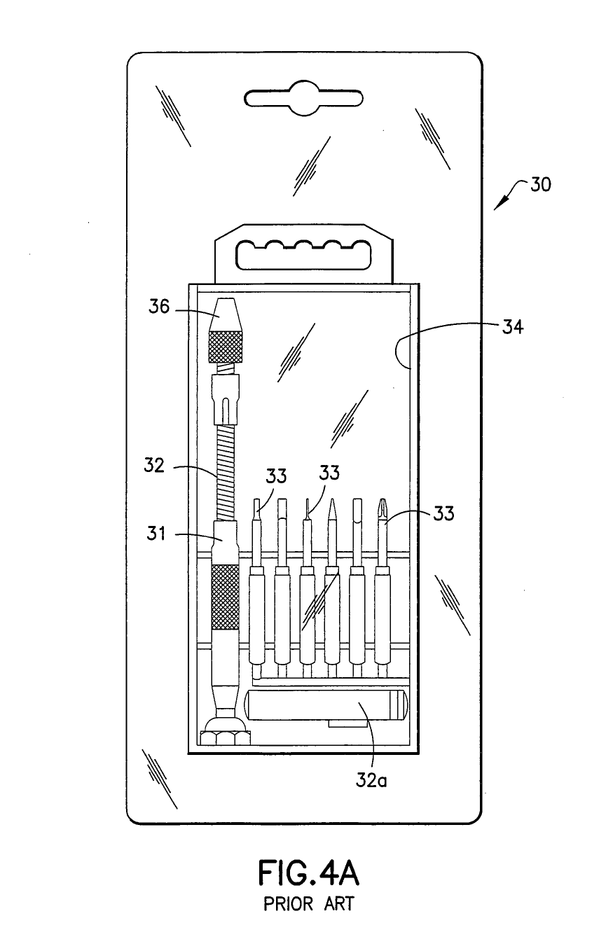

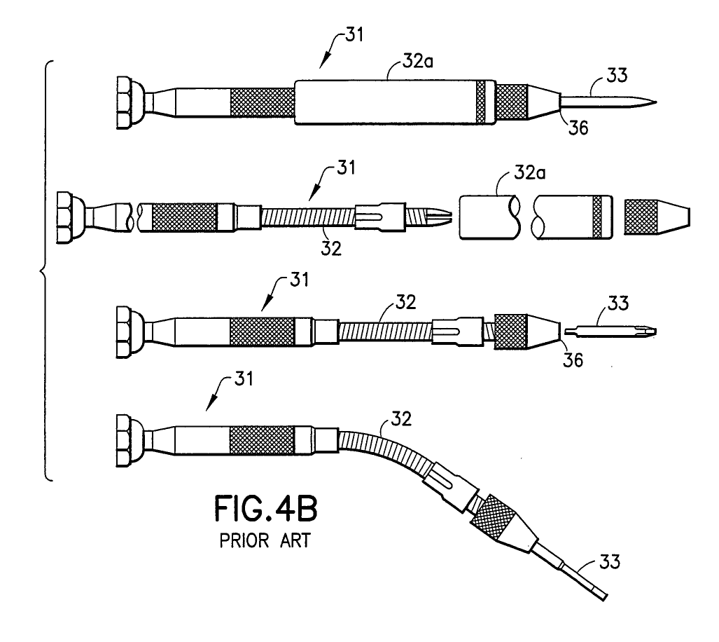

Referring to FIGS. 16-17 there is shown, respectively, side and top views of a typical conventional precision tool bit 80 (FIG. 16), a side elevational view of a typical conventional non-precision double-ended tool bit 85 (FIG. 17), and the double-ended precision tool bit 60 of the present invention (FIG. 13). FIGS. 11-13 are shown in accurate proportional scale for size and configuration comparisons. Tool bit 80 is generally formed of cylindrical wire stock and includes an elongated body portion 80a and an elongated single bit end 80b and proximate end ears 80c for locking the bit in the tool (not shown in FIG. 11, but generally shown in FIGS. 4A and 4B). It was generally believed and the direction of the conventional that only a single bit could be accurately minimal for a precision tool, as generally shown in FIGS. 1-4B. Referring now to FIG. 12, conventional double-end tool bit 85 has a body portion 85a and a first bit end 85b and second bit end 85c. Tool bit end lengths x were generally at least about ½ inch or 17 mm, with the distance across the body flats being generally at least about 1/4 inch or 8.5 mm. The art was directed to a tool bit length of at least about 17 mm for an accurately mechanical hex bar stock of about 8.5 mm in construction. The precision tool bit 60 of the present invention, as shown in FIG. 18, has a body portion of regular hexagonal cross-section with a width of no more than about 4 mm across the flat sides of the regular hexagon, and a body length y of no more than about 8-10 mm, with a tool bit 60b integrally formed at respective opposite ends of the body portion. Each tool bit 60b length z is no more than about ⅜ inch or about 8-10 mm. That is, the present invention has found that it is practical to production machine bar stock of 4 mm and produce precision bit ends having bit end lengths of 8-10 mm and a body length of 8-10 mm, or an overall length of 24-30 mm. The afore described tool bit and the handle construction provides a practical multiple-in-1 precision tool. Tool bit ends 60b maybe of different drive sizes and/or configurations. It is within the contemplation of the present invention to provide different drive configurations such as flat blade screwdriver, Phillips, and TORX configurations, by way of example.

In the aforesaid manner of construction, the user in one mode of use, grasps the handle body with the thumb and middle fingers and places the end of the index finger in the proximate end recess of the handle cap for fine precision use, as shown in FIGS. 14 and 15. Handle cap swivels within handle body proximate recess to further contribute to fine control precision grip use.

There is provided by the present invention a versatile multiple-in-1 pocket precision drive tool, namely a 12-in-1 pocket precision drive tool and a 12-in-1 stubby or mini handle cap precision drive tool. The present tool provides mag/demag functionality as well as multiple nut drive functionality. This most versatile multiple use construction is readily and practically stowed and within a shirt pocket. The clear plastic construction of the first handle body portion permits the user to identify the desired stowed precision tool bit.

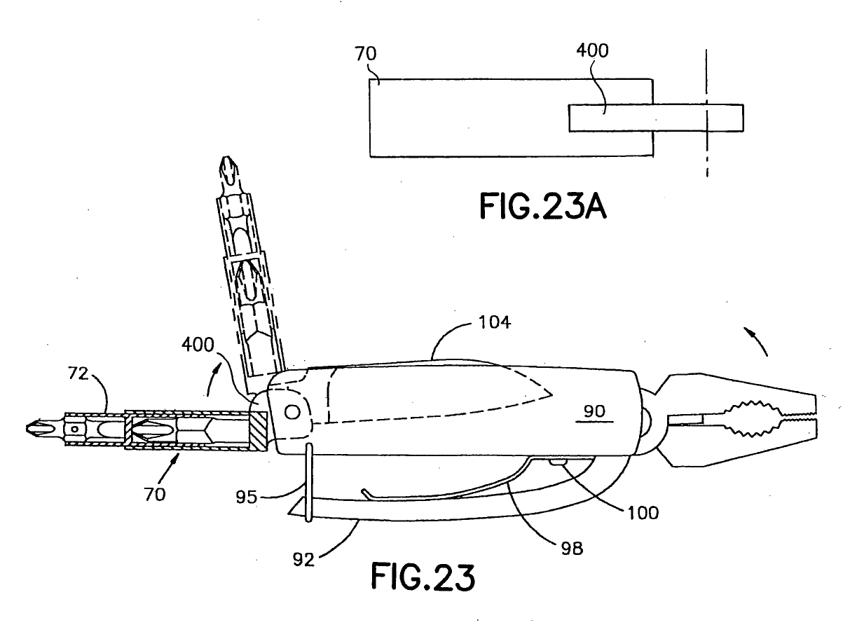

Referring now, and more particularly, to FIGS. 23 to 25, there is shown a number of alternate and improved modifications and alternate constructions of the hand tool according to selected embodiments of the invention with various implements generally pivotably mounted to at least the distal end of one of a selected tool handles. It is particularly noted that the contents of U.S. Ser. No. 09/901,305 filed Jul. 9, 2001 are incorporated in their entirety by reference, including all drawings, figures, discussion, disclosures, and claims, as well as the contents of each of the previous applications noted as priority documents therein, as an aid to the reader in understanding the present invention.

It will be appreciated that the longer master or outer sleeve (to be described) securely holds and precludes rotation between itself and the shorter servant or inner'sleeves of the of oppositely disposed tool elements at the distal ends of the long inner sleeve. Nevertheless, it is also within the practice of the invention for the master and/or servant sleeves, as well as the screwdriver bits themselves to be either symmetrical or asymmetrical (long or short reach), similar to that disclosed in our U.S. patent application Ser. No. 08/620,471 incorporated herein by reference.

As best shown with like numerals, the tool of FIGS. 23-25, illustrate another multiple-in-1 hand tool with a pivotable sleeve for a multiple-in-one type driver tool, but with only one movable jaw 86 as shown by the reference arrow, the other jaw 88 being fixed to larger fixed handle 90. The movable handle 92 is pivotable about the fixed handle by means, of axis point or pivot pin 94 and such handle is suitably held in the closed position by a pivotable U-shaped element 95 which may also, serve as a loop for holding the improved hand tool to one's belt loop or chain attached to a pair of pants. Optionally, a spring element, 98 may be secured to the handle 90 by means of fastener 100 to biasably urge the movable jaw 86 to an open position.

The fixed handle 90 is suitably equipped with a plurality of pivotable tool implements, such as a large knife 104 or other implements common in a multiple-in-one driver tool. The releasable locking mechanism (not shown) for holding such tool implements in the open position does not form part of the invention and is well known and conventional.

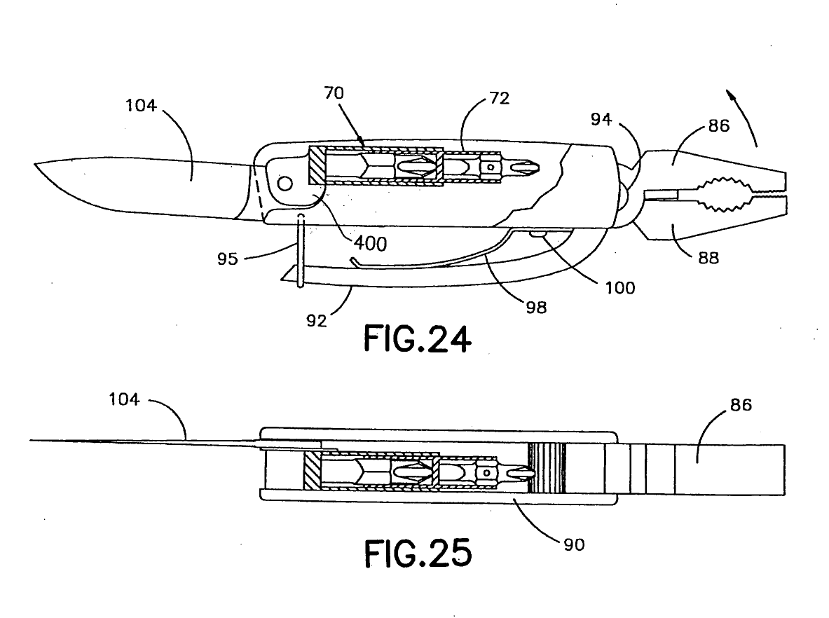

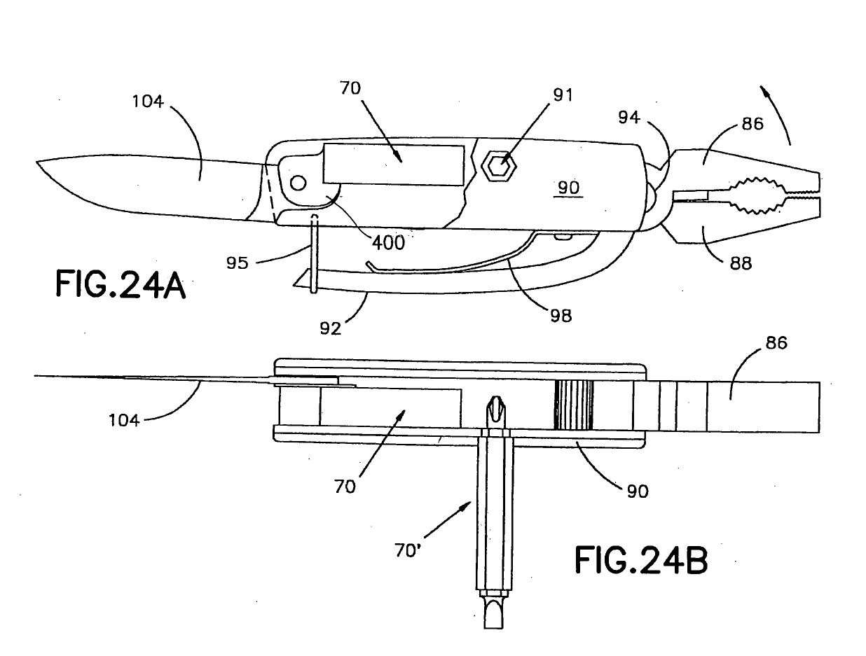

In the embodiment of FIGS. 24A and 24B, the multiple-in-1 driver sleeve 72 with dual bits at opposite ends thereof is shown removed from the pivotable sleeve 70 and positioned as an alternate driver sleeve 70′ in one of the pair of hexagonal bores 91 provided in a side of the handle 90.

FIGS. 24A and 24B show the tool also, optionally, having at least one dual transverse hexagonal crossbore 91 in one or both handle sides (one shown). The crossbore 91 is of a desired, predetermined size for mating with either or both of an hexagonal driver bit or a hexagonal sleeve hexagonal driver bit, thereby enabling the tool be gripped about the handle, with the 4 in 1 screwdriver 70‘midway between a user’s four fingers. With such a tool arrangement, one has greater flexibility in employing such tool for various applications of driving or un-driving fasteners. Dual hexagonal crossbores 91 enable greater torque capability, and less “slippage” and/or wearing of the hexagonal bores provided in the laminated handle sides, which are' conventionally made either entirely or laminated of metal, plastic, or the handle sides could even be a combination of both materials. In any event, one hexagonal connection is adequate for driving fasteners. Of course, suitable clearance must be provided between the side walls or side bolsters for a protruding drive bit, and there can be no interference with' any of the other pivotable elements or tools in the folding hand tool. Nevertheless, depending upon the size of the tools and the handle length, a tool can be pivoted into the open position, if necessary for clearance.

It should be understood, that while the sleeve 72, screw driver 20, and holes 91 are hexagonally shaped, it is contemplated that any shape capable of transferring torque from a tool handle to a hand tool, i.e. a square, star shape, triangle shape etc., may be used to effectuate the present invention.

A hand tool has a pliers with pivotably disposed handles with one handle having a closed ended sleeve pivotably connected to one handle head for removably operably receiving a tool with the sleeve non-removably bits pivoting 180 from an inoperable position between the handle sides to an operable position outside the same, and the other handle has a plurality of bladed tools pivotally connected to the other handle end.

It is contemplated that the closed ended sleeve includes an internal shape complementary to the external shape of the sleeve and the tool bits enabling storage of these elements tightly within the sleeve.

It should also be noted that a supporting wing member 400 may extend and join the sleeve to the pivot point. The wing member is only optionally provided in the view to enable conception of the position. It is to be understood, that the wing member shown is optional and is necessary to only one embodiment of the present invention, not to the invention as a whole. Therefore, it is to be understood, that the present invention may be practiced without wing member 400.

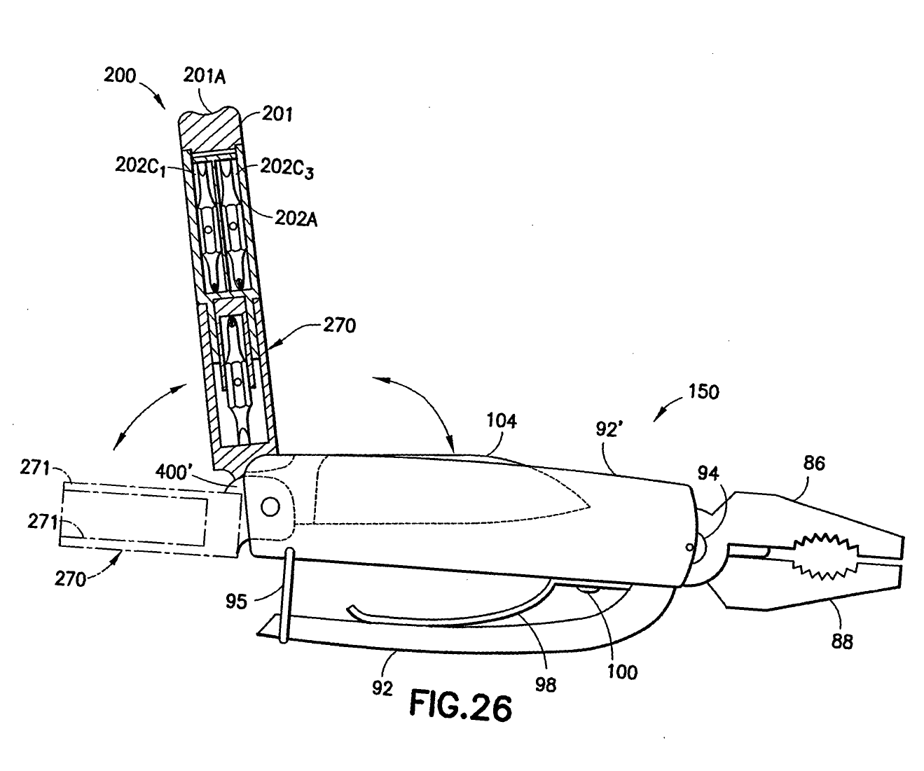

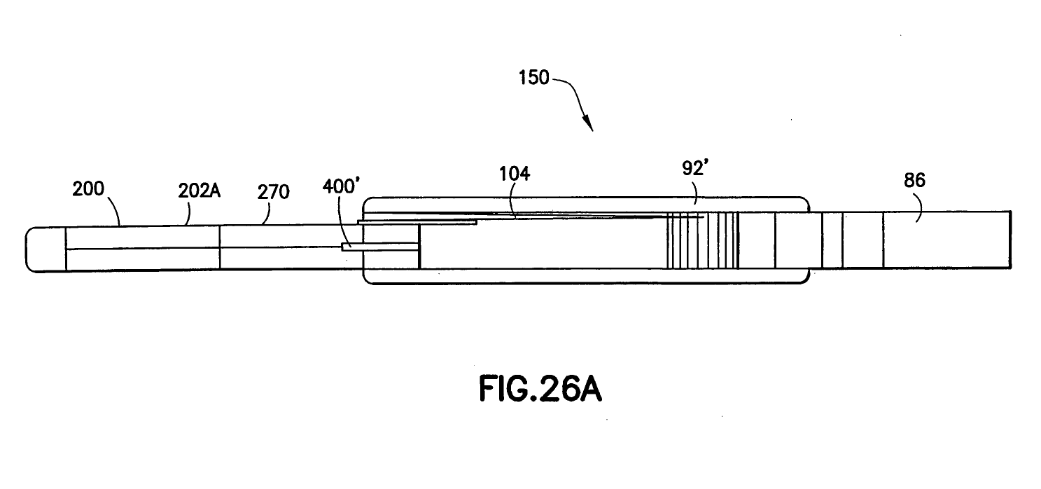

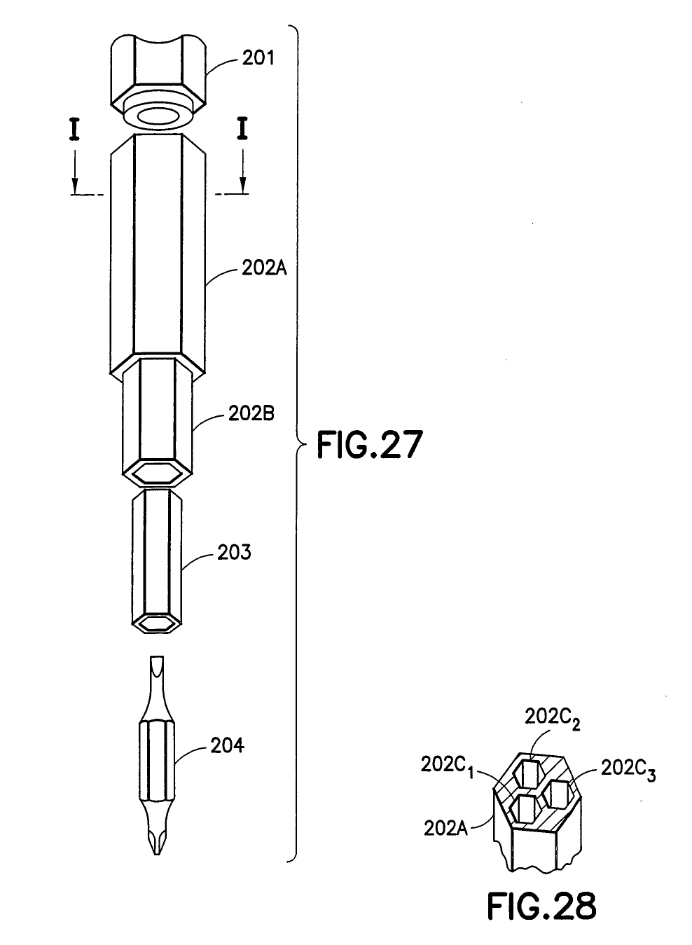

Referring now to FIGS. 26 to 30 an alternative embodiment of a precision multiple-in-1 tool 150 similarly includes one movable jaw 86 as shown by the reference arrow, and a second other jaw 88 being fixed to a larger fixed handle 92′. The moveable handle 92 is pivotable about the fixed handle 92′ by means of an axis point or pivot pin 94 and such handle is suitable held in a closed position by pivotable U-shaped element 95 which may also serve as a loop for holding the improved multiple-in-one precision hand tool to one's belt loop or chain attached to a pair of pants. Optionally, spring element 98 may be secured to the handle 92′ by means of fastener 100 to biasably urge movable jaw 86 to an open position.

The fixed handle 92′ may be suitable equipped with a plurality of pivotable tool implements, such as a large knife 104 and several types of multiple-in-1 hand tool related to those shown in the related FIGS. As noted above, a releasable locking mechanism (not shown) for holding such tool implements in the open position does not form part of the invention and is well known and convention.

A pivotable driver sleeve 270 is pivotably attached to fixed handle 92′ and is operable from a closed position to a use position as shown. Driver sleeve 270 receivably and releaseably secures one embodiment of a multiple-in-1 hand tool, shown here as multiple-in-1 precision screw driver 200. Precision driver 200 includes a storage body 202A housing an array of storage cavities 202C₁, 202C₂, and 202C₃ to releaseably house respective bits 204 (either precision or non-precision).

Driver sleeve 270 includes respective driver sleeve walls 271. It should be understood by the reader that although the internal geometry of driver sleeve 270 and the respective external geometry of precision driver 200 are shown as hexagonal, this is one embodiment only, and it is complemented that any geometry capable of releasably and securably storing a hand tool (in this case screw driver 200) may be used. i.e. rectangular, square, trapezoidal, triangular, star shaped, irregular etc. It should also be understood, that the external geometry of hand tool 200, shown here as driver 200, may have any external geometry desired including a smooth/rough-gripping surface, hexagonal, round, ribbed etc., as long as the surface enables a user to operate the hand tool.

A cap 201 is releasably and pivotably secured to a first axial end of storage body 202A and optionally includes a central depression 201A to aid in use. Cap 201 may be removed to provide access to various tool bits 204 held in respective storage cavities 202C 1-3. Cap 201 may optionally employ an elastic snap fit or a spit-thread design to enable rapid and simple attachment to the axial end of storage body 202A. Where depression 201A is employed, a user's finger tip ofpalm may rest within depression and maintain precision driver 200 in an aligned position with an item to be driven.

An optional wing member 400′joins driver sleeve 270 to the pivot point of the tool handle, as shown. Wing member 400′ serves to additionally stiffen the pivot juncture and aid in long tool life. As above, it should also be noted that supporting wing member 400′ is only optionally provided in the view to enable conception of the position. It is to be understood, that the wing member shown is optional, may be optionally positioned, and is necessary to only one embodiment of the present invention, not to the invention as a whole. Therefore, it is to be understood, that the present invention may be practiced without wing member 400′.

A second storage body portion 202B extends from the other axial end of storage body 202A which is shaped to receive either one of an optional intermediate sleeve member 203 for securing precision bits 204 or regular sized driving bits (not shown) employed without the use of optional intermediate sleeve member 203. It is also noted that the receiving cavities 202C₁₋₃ may be shaped to hold either precision or non-precision tool bits. As a consequence, it should be understood by those skilled in the art that multiple-in 1 tool 150 in each embodiment allows the use of multiple sized bits/drivers for user convenience while providing safe and secure storage.

An external surface of precision driver 200 and an internal geometry of driver sleeve 270 (along with intermediate sleeve member 203 etc.) are selected to securely mate in use and retain driver 200 while moving from the open position to the storage position, while allowing the multiple-in-1 hand tool to adapt as needed to precision or non-precision tool bits. As shown, the external surface of precision driver is hexagonal which aids in gripping by a user and convenient positioning of storage cavities 202C₁₋₃, but geometric surface shapes are envisioned as noted above.

Also as shown, the internal geometry of driver sleeve 270 includes a plurality of receiving/gripping surfaces or walls 271 spaced to slip over and retain opposed surfaces of the external hexagonal surface of driver 200, in either an snug-fit, elastic, magnetic, snap-fit, or other manner. In this manner, during storage, driver sleeve 270 securely retains precision hand tool-driver 200. An alternative embodiment (not shown) includes additional latching means on gripping means on surfaces 271 to secure mating with respective receiving latching means on an external surface of storage body 202A to create a positive snap-fit with precision driver 200.

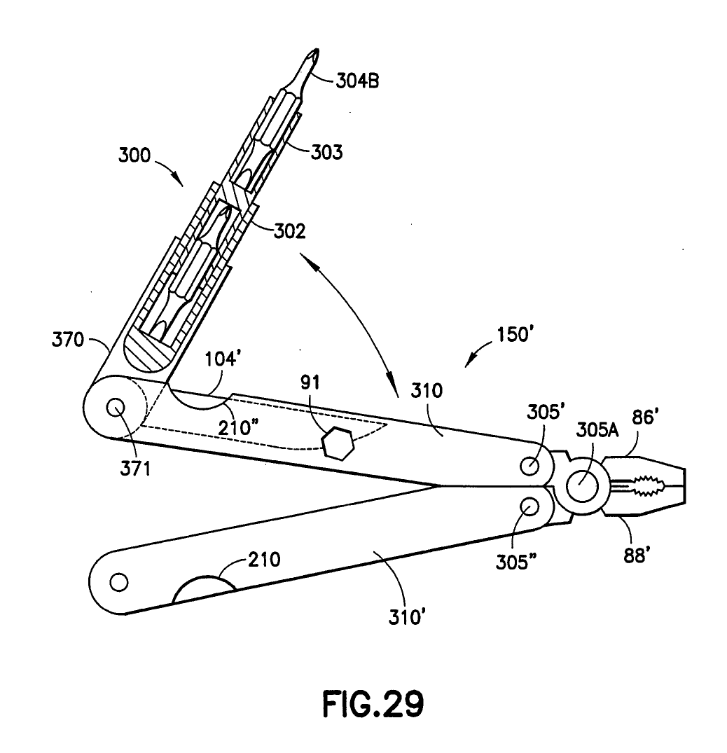

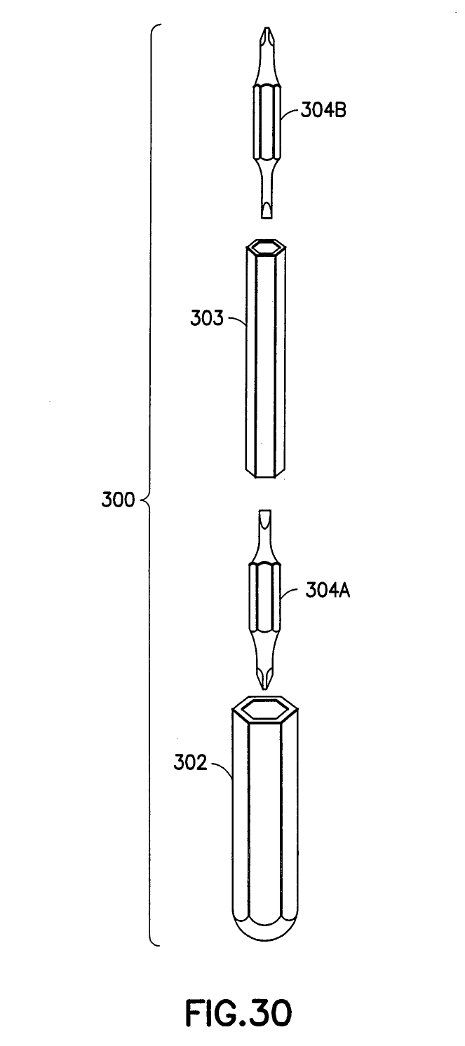

Referring now to FIGS. 29 and 30 an alternative embodiment of a precision multiple-in-1 hand tool 150′ includes a form of a Leatherman-type tool as a tool handle having an implement, for example blade 104′ or other similar implements common to this type of tool.

A first and second handle 310, 310′ are provided with longitudinal inner cavities extending from a free end as shown remote from opposing jaws 86′ and 88′joined at a series of pivot points 305A, 305′, and 305″. Longitudinal inner cavities are shaped to receive opposing jaws 86′, 88′ when not in use and pivotably hold a variety of tools (for example large blade 104′), in this precision multiple-in-1 tool 150′, accessible via handle cut-outs 210′, 210″.

A separable multiple-in-1 precision hand tool/driver tool or screw driver 300 is pivotably mounted in a driver sleeve 370 rotatable 180 degrees about an axis of a pivot pin 371 to be movable between a use/access or extended position and a storage or retained position. Driver tool 300 is shown mid-way between the use and the storage positions.

Driver sleeve 370 is shaped as a closed ended socket to receive an external surface of a storage body 302 of driver 200. An intermediate sleeve 303 is removably positionable longitudinally within an inner cavity in storage body 302. As shown, a hexagonal external surface of intermediate sleeve 303 mates with a hexagonal inner surface of storage body 302 in a snug slip fit enabling secure rotation of storage body 302 and allowing to transfer torque to sleeve 303 where screwdriver 300 is used in conjunction with sleeve 370 to provide additional torque. It should be understood, that respective internal and external surfaces are selected for user convenience and use security. Consequently, it is envisioned that alternate geometric or amorphous geometries may be selected for inner and external surface to secure a snug fit, prevent loss, while providing user effectiveness i.e. square, rectangular, triangular, star shaped etc.

Precision bits 304A, 304B (may optionally be non-precision bits without sleeve 303), having hexagonal outer surfaces are slidably retained within similarly shaped opposing inner cavities longitudinally aligned in intermediate sleeve 303, as shown. In this manner, driver 300 enables rotation of storage body 302 to transfer torque through intermediate sleeve 303 to precision bits 304A, 304B while allowing hand tool 300 to be removed and used by hand by a user as a precision or other hand tool in a manner allowing guided use.

In the present embodiment, it is noted that a user may employ driver 300 either retained within driver sleeve 370 or removed from driver sleeve 370 allowing delicate hand manipulations, or optionally secure intermediate sleeve in hole 91. It is also noted that intermediate sleeve 303 includes an outer shape substantially similar to larger sized bits (not shown) so that larger sized bits may be inserted into and used in storage body 302, for use without intermediate sleeve 303.

Another benefit of the present invention is that a smooth axial end, opposite intermediate sleeve 303, allows a user to rest a guiding finger-tip (not shown) or a palm-portion (also not shown) on the axial end while rotating the hand tool-driver 300 with the remaining finger-tips.

In the claims, means- or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Although the present invention has been described in some detail by the way of illustration and example for purposes of clarity and understanding, it will of course be understood that various changes and modifications may be made in the form, details and arrangements of the elements and parts without departing from the scope of the invention as set forth in the adjoined claims.

What is claimed is:

1. A multiple-in-1 hand tool comprising;
tool bit members, each member having a body and oppositely disposed ends and having a tool bit disposed at each said end;
a tool bit driver in combination with a tool handle;
said driver comprising a handle having a proximate end and a distal end, and having elongated compartments to receive said tool bit members for storage within the compartments; and
said driver handle further comprising a handle cap, said driver handle cap comprising means for removably and rotatably attaching the cap to the handle proximate end to cover the compartments with the tool bit members in a closed position, said handle cap being rotatable in a closed position.

2. A multiple-in-1 hand tool comprising:
a handle in combination with a tool handle;
said handle having a proximate end and a distal end, and being formed with a plurality of compartments adjacent a proximate end for storing tool bits; and
a handle cap, said handle cap having a distal end and means for removably and rotatably attaching a handle cap distal end to said handle proximate end to cover said compartments containing the tool bits in a handle cap closed position, said handle cap being rotatable in the closed position.

3. The precision tool of claim 2, wherein:
the handle cap distal end is contoured for receiving the end of an index finger for precision tool bit drive use.

4. A precision multiple-in-1 hand tool comprising:
a handle in combination with a tool;
said handle having a proximate end and a distal end;
a handle cap removably and rotatably attached to the handle proximate end;
a shank having a proximate end disposed in the distal end of the handle and being extendable from the handle distal end,
a shank sleeve disposed at the distal end of the shank,
at least one tool bit member, one said tool bit member being operably disposable in said shank sleeve, said handle cap having means for restraining one tool bit member, and said handle being formed with elongated compartments for stowing a plurality of said tool bit members, each tool bit member comprising a body and oppositely disposed precision tool bits, wherein the length of each tool bit is about equal to the length of the member body; and
said handle cap covers the handle compartments with the stowed tool bit members in a closed position, and said handle cap being rotatable in the closed position.

5. The precision pocket tool of claim 4, wherein:
said handle cap being having a first contour to positionably receive the end of an index finger for precise tool use.

6. A multiple-in-1 hand tool comprising:
at least one interchangeable tool bit member, opposed jaw tool members, first and second elongated handles having oppositely disposed first and second ends;
said jaw tool members being operably disposed at said first ends;
said first handle having opposed sides forming an elongated cavity;
a sleeve comprising a one-piece unitary construction formed with a body and having a closed-end and an open end, said open end being formed for removably and operably holding said tool bit member, said tool bit member being disposed in said sleeve;
means for pivotably fixedly connecting the sleeve adjacent the first handle second end so that the sleeve is non-removable, whereby the sleeve and the tool bit member are pivoted from a first position disposed away from the first handle to a second position disposed in the first handle cavity so that the sleeve and tool bit member are inoperably stowed in the first handle without having to remove and separately stow the tool bit member or sleeve outside the first handle cavity thereby permitting ready alternate pliers or selected tool bit use.

7. A multiple-in-1 hand tool, according to claim 6, wherein:
said tubular body having an outer surface, said sleeve closed-end having a flat end wall portion, said flat end wall portion extending to the tubular body outer surface.

8. A multiple-in-1 hand tool, according to claim 7, wherein:
said tool bit member comprising a double-ended tool bit, said double-ended tool bit being disposed between said first handle sides with said sleeve disposed in said inoperable position.

9. A multiple-in-1 hand tool, according to claim 6, wherein said tubular body being formed with a wing member extending away from the outer surface of the tubular body.

10. A multiple-in-1 hand tool, according to claim 9, wherein:
said wing member extends axially from the flat end wall portion along said outer surface of said tubular body.

11. A multiple-in-1 hand tool comprising:
at least one interchangeable tool bit member, opposed pliers jaws, first and second elongated handles having oppositely disposed first and second ends, said pliers jaws being operably disposed at said first ends;
said first handle having opposed sides forming an elongated cavity, a bladed tool, and means for pivotably connecting the bladed tool to the first handle adjacent the first handle second end;
a sleeve comprising a one-piece unitary construction formed with a substantially tubular body, and said tubular body having a closed-end and an open end, said open end being formed for removably storing said tool bit member, said tool bit member being disposed in said sleeve, means for pivotably fixedly connecting the sleeve adjacent the first handle second end so that the sleeve is non-removable, whereby the sleeve and the tool bit member are pivoted from a first position disposed away from the first handle to a second position disposed in the first handle cavity so that the sleeve and tool bit member are inoperably stowed in the first handle without having to remove and separately stow the tool bit member or sleeve outside the first handle cavity thereby permitting ready alternate pliers or tool bit use;
said tubular body having an outer surface, said sleeve closed-end having a flat end wall portion, said flat end wall portion extending to the tubular body outer surface; and
said tool bit member comprising a double-ended tool bit, said double-ended tool being disposed between said first handle sides with said sleeve disposed in said inoperable position.

12. A multiple-in-1 hand tool, according to claim 11, wherein:
said tubular body being formed with a wing member extending away from the outside of the tubular body.

13. A multiple-in-1 hand tool, according to claim 11, wherein:
said wing member extends axially along said outside of said tubular body.

14. A multiple-in-1 hand tool, comprising:
a tool bit member and a tool handle;
said tool handle having a sleeve comprising a one-piece unitary construction formed with a tubular body, and said tubular body having a closed-end and an open end, said open end being formed for removably storing said tool bit member, said tool bit member being disposed in said sleeve in a storage mode and removable for use during a use mode;
means for pivotably fixing said closed end of said tubular body to said tool handle whereby the sleeve and the tool bit member are pivoted from a first position disposed away from the first handle to a second position disposed in a first tool handle cavity so that the sleeve and tool bit member are inoperably storable in a first handle cavity without having to remove and separately store the tool bit member or sleeve outside the first handle, thereby permitting ready alternative tool bit member use apart from said tool handle.

15. A multiple-in-1 hand took, according to claim 14 wherein:
said tubular body being formed with a wing member extending axially along the outside of the tubular body.

16. A multiple-in-1 hand tool, according to claim 14, wherein:
said tool bit member further comprises a body and an oppositely opened tool bit storage and holding cavity for receiving at least a tool bit during said use mode of said hand tool;
a plurality of storage cavities in said body opposite said storage and holding cavity for removably storing a plurality of tool bits; and
a top member on said tool bit member removably covering said plurality of storage cavities while providing a ready access.

17. A multiple-in-1 hand tool, according to claim 16, further comprising
an intermediate sleeve slidably storable in said oppositely opened tool bit storage and holding cavity for receiving a precision tool bit during said use and enabling a retainment of said tool bit during staid storage mode.

18. A multiple-in-1 hand tool, according to claim 14, wherein:
at least two tool bit members are disposed in said sleeve, whereby said two tool bit members enable a plurality of removable and useable tool bit members with a plurality of storage and holding cavities.

19. A multiple-in-1 hand tool, according to claim 11, wherein:
at least two tool bit members are disposed in said sleeve, whereby said two tool bit members enable a plurality of removable and useable tool bit members with a plurality of storage and holding cavities.

20. A multiple-in-1 hand tool, according to claim 14, wherein:
at least two tool bit members are disposed in said sleeve, whereby said two tool bit members enable a plurality of removable and useable tool bit members with a plurality of storage and holding cavities.

21. A tool kit, comprising:
a hand tool including multiple and interchangeable tool bits in at least a storage body;
at least one tool handle having said first handle having opposed sides forming an elongated cavity and a one piece unitary sleeve member pivotably joined relative to a first end of said tool handle and having a closed-end and an open end, said open end being formed for removably storing said hand tool; and
said hand tool being removably disposed in said sleeve, whereby the sleeve and the hand tool are pivoted from a first position disposed away from the first handle to a second position disposed in the first handle cavity so that the sleeve and hand tool are inoperably stowed in the first handle without having to remove and separately stow the tool bit member, handle, or sleeve outside the first handle cavity thereby permitting ready alternate use of said tool kit.
